(19) United States
(12) Patent Application Publication
(10) Pub. No.: US 2006/0198034 A1
(43) Pub. Date: Sep. 7, 2006

(54) Molded glass lens with a lens holding cylinder integrated, and a production device thereof

(75) Inventors: Shuji Shikano, Yaita-shi (JP); Takeshi Masujima, Yaita-shi (JP); Hideyuki Takeda, Yaita-shi (JP); Yoshio Tetsuka, Yaita-shi (JP)

Correspondence Address: DARBY & DARBY P.C., P. O. BOX 5257, NEW YORK, NY, 10150-5257, US

(73) Assignee: MORITEX CORPORATION, Shibuya-ku (JP)

(21) Appl. No.: 11/362,276

(22) Filed: Feb. 24, 2006

(30) Foreign Application Priority Data
Feb. 24, 2005 (JP) 2005-49655

(51) Int. Cl. G02B 7/02

(52) U.S. Cl. 359/811

(57) ABSTRACT

A molded glass lens with a lens holding cylinder integrated, comprising the lens holding cylinder having an adequate number of through holes formed in it and forming a hot working space together with a mold during molding and a glass lens proper molded in the lens holding cylinder, wherein the excessive portion of the base material of the lens has flowed into said through holes, and also proposes a production device thereof.

### INCORPORATION BY REFERENCE

The present application claims priority under 35 U.S.C. §119 to Japanese Patent Application No. 2005-49655 filed on Feb. 24, 2005. The content of the application is incorporated herein by reference in its entirety.

### FIELD OF THE INVENTION

The present invention relates to a molded glass lens used in an optical device, particularly a small molded glass lens with a lens holding cylinder integrated, and a production device thereof.

### BACKGROUND OF THE INVENTION

A molded glass lens refers to a glass lens produced by hot-working glass, i.e., the base material of the lens using a mold. It is known that unless the volume of the lens base material is controlled highly precisely when the lens is produced, the wall thickness and the facial forms of the lens cannot be precisely worked, hence that a lens satisfactory in view of lens performance such as focal distance cannot be obtained. The level required in the volume control of the lens base material becomes more severe if the produced molded glass lens becomes smaller.

However, the highly accurate volume control of the lens base material raises the production cost and affects the product price and delivery period of the molded glass lens.

So, various methods have been proposed for producing a precisely molded glass lens while the level required in the volume control of the lens base material is kept low.

For example, Japanese Pat. No. JP60-171230A proposes a molded glass lens producing device, in which divisional slide cores are installed around the entire lateral circumference of a mold consisting of an upper mold member and a lower mold member in such a manner that the slide cores can advance to and recede from the mold and that the mold and the slide cores in their advancing positions form a hot working space; and slide pins capable of going into and out of the space are installed in the slide cores so that they can be made to go into and out of the space for absorbing the fluctuation of the volume of the lens base material.

Furthermore, Japanese Pat. No. JP60-171232A proposes a molded glass lens producing device, in which divisional slide cores are installed around the entire lateral circumference of a mold consisting of an upper mold member and a lower mold member in such a manner that the slide cores can advance to and recede from the mold and that the mold and the slide cores in their advancing positions form a hot working space; and holes are formed in the slide cores so that the amount of the lens base material flowing into the holes corresponds to the fluctuation of the volume to be absorbed.

Still furthermore, Japanese Pat. No. P3161622 describes a molded glass lens producing device, in which inner cylinders are arranged around an upper mold member and a lower mold member of a mold; a common outer cylinder is arranged around the inner cylinders; and the inner cylinder for the lower mold member is provided with a metallic frame having a flexible portion capable of being caulked; so that when the upper mold member and the lower mold member are used for hot working, the flexible portion of the metallic frame can be bent and caulked for integration with the circumferential edge of the glass lens to be molded, in which case the amount of the lens base material flowing into the groove portion formed by the bent flexible portion corresponds to the fluctuation of the volume to be absorbed.

Still furthermore, Japanese Pat. No. P2694690 proposes a molded glass lens producing device, in which a support cylinder is arranged around an upper mold member and a lower mold member of a mold, in such a manner the upper mold member, the lower mold member and the support cylinder form a hot working space for a lens base material, wherein a chamfered portion is formed at the circumferential edge of the upper mold member, to ensure that the amount of a lens base material flowing into the space added by the chamfered portion to the hot working space corresponds to the fluctuation of the volume to be absorbed.

Still furthermore, Japanese Pat. No. JP2004-271782A proposes a molded glass lens producing device, in which a lens holding cylinder is arranged around an upper mold member and a lower mold member, so that the space formed by the upper mold member, the lower mold member and the lens holding cylinder can be used as a hot working space; and void portions are formed in the inner circumferential face of the lens holding cylinder so that the amount of a lens base material flowing into the void portions corresponds the fluctuation of the volume to be absorbed; or the lens holding cylinder is made of a porous metal such as a foam metal, to have numerous pores, so that the amount of the lens base material flowing into the void portions consisting of the pores corresponds to the fluctuation of the volume to be absorbed.

Still furthermore, Japanese Pat. No. JP2004-279879A proposes a constitution in which a cylindrical holder for holding a lens is provided with a thin deformable portion capable of being deformed by a pressing pressure applied from the inner circumferential side; and the circumferential edge of the lens has an extra portion to be kept in pressure contact with the deformed deformable portion.

The above-mentioned conventional methods have the following problems.

The method of JP60-171230A has problems that depressions corresponding to the slide pins are formed on the lateral face at the circumferential edge of the molded glass lens, and that the molding device and the mold are very costly since they are complicated.

The method of JP60-171232A has a problem that since the lateral face at the circumferential edge of the molded glass lens has projections formed due to excessive glass contrary to patent document 1, the method of holding the glass lens is restricted.

In the method of P3161622, if the width of the groove portion is about 0.5 mm, the flowing of the lens base material into the groove portion encounters resistance, and as a result, an appropriate pressure acts on the molded face of the lens base material, allowing a precise glass lens to be molded. However, if the width of the groove portion is larger than it, an excessive amount of the lens base material is likely to flow into the groove portion formed around the lens base material, and as a result, the pressure acting on the molded face of the lens base material declines, not allowing a precise lens to be molded. So, this method has a problem that the size of the lens capable of being produced by this method is limited to smaller than a certain value.

In the method of P2694690, at the circumferential edge of the molded glass lens, the face portion in contact with the support cylinder can be a reference face, but the portion corresponding to the chamfered portion changes in form in response to the excessive amount of the lens base material. So, the portion other than the said face portion cannot work as a reference face, and there arises a problem that the method of holding the molded glass lens is restricted.

In one method of JP2004-271782A, since the void portions are formed in the inner circumferential face of the lens holding cylinder, it is troublesome to form the void portions, generally raising the cost of the produced glass lens. Furthermore, the method of using a porous metal for holding the lens has such problems that the material is expensive, low in strength and difficult to weld, and that another material is necessary for keeping airtightness.

In the method of JP2004-279879A, since it is necessary to prevent that the lens base material runs off from the clearance formed between the cylindrical holder and the mold, the inner diameter of the holder must be precise to raise the working cost.

The object of this invention is to solve the above-mentioned problems of the conventional methods.

### SUMMARY OF THE INVENTION

To solve the above-mentioned problems, a first subject matter of this invention proposes a molded glass lens with a lens holding cylinder integrated, comprising the lens holding cylinder having an adequate number of through holes formed in it and forming a hot working space together with a mold during molding and a glass lens proper molded in the lens holding cylinder, wherein the excessive portion of the base material of the lens has flowed into said through holes.

A second subject matter of this invention proposes a device for producing a molded glass lens with a lens holding cylinder integrated, by hot-working the base material of the lens using a mold, characterized in that the lens holding cylinder is arranged around an upper mold member and a lower mold member during molding, to constitute the space formed by the upper mold member, the lower mold member and the lens holding cylinder as a hot working space, and that an adequate number of through holes are formed in the lens holding cylinder.

In the first and second subject matters of this invention, the lens base material is hot-worked in the hot working space formed by the upper mold member, the lower mold member and the lens holding cylinder, to produce a molded glass lens. In this case, the excessive lens base material flows into the through holes formed in the lens holding cylinder, for being absorbed.

In the molded glass lens produced as described above, since the lens holding cylinder is integrally installed around the circumferential edge of the lens, it does not happen that the excessive portion projects beyond the circumferential edge as in the method of patent document 2, and the lens can be precisely supported in an optical apparatus by the lens holding cylinder.

Furthermore, since the means for absorbing the excessive lens base material is the through holes formed in the lens holding cylinder, the lens can be worked easily and highly precisely, and the diameter of the holes can be decided to adequately set the flow resistance of the excessive lens base material. So, a highly precise glass lens can be produced by molding.

A third subject matter of this invention proposes a molded glass lens with a lens holding cylinder integrated, comprising the lens holding cylinder forming a hot working space together with a mold during molding and a glass lens proper molded in the lens holding cylinder, wherein the excessive portion of the base material of the lens is swollen in contact with the inner circumferential face of said lens holding cylinder.

A fourth subject matter of the invention proposes a device for producing a molded glass lens with a lens holding cylinder integrated, by hot-working the base material of the lens using a mold, characterized in that the lens holding cylinder is arranged around an upper mold member and a lower mold member during molding, to constitute the space formed by the upper mold member, the lower mold member and the lens holding cylinder as a hot working space, and that a chamfered portion is formed at the circumferential edge of at least either the upper mold member or the lower mold member, to be kept in contact with the inner circumferential face of the lens holding cylinder during molding.

In the third and fourth subject matters of this invention, when the glass lens is molded by hot-working the lens base material in the hot working space formed by the upper mold member, the lower mold member and the lens holding cylinder, the excessive lens base material is swollen in contact with the inner circumferential face of the lens holding cylinder, for being absorbed.

In the molded glass lens produced as described above, since the lens holding cylinder is integrally installed around the circumferential edge of the lens, it does not happen that the form of the circumferential edge of the lens changes in response to the excessive amount of the lens base material, to restrict the holding method as in the method of P2694690.

### BRIEF DESCRIPTION OF THE DRAWINGS

FIG. 1 is a sectional view for explanatorily showing the components of the production device used in Embodiment 1 of this invention.

FIG. 2 is a sectional view showing a lens that is being molded in the production device used in Embodiment 1 of this invention.

FIG. 3 is a sectional view showing a molded glass lens of this invention molded in Embodiment 1 of this invention.

FIG. 4 is another sectional view showing a molded glass lens of this invention molded in Embodiment 1 of this invention.

FIG. 5 is a sectional view for explanatorily expressing the components of the production device used in Embodiment 2 of this invention.

FIG. 6 is a sectional view showing a lens that is being molded by the production device used in Embodiment 2 of this invention.

FIG. 7 is a sectional view showing a molded glass lens of this invention molded in Embodiment 2 of this invention.

FIG. 8 is another sectional view showing a molded glass lens of this invention molded in Embodiment 2 of this invention.

### PREFERRED EMBODIMENT OF THE INVENTION

This invention is explained below in detail in reference to the drawings showing embodiments.

### Embodiment 1

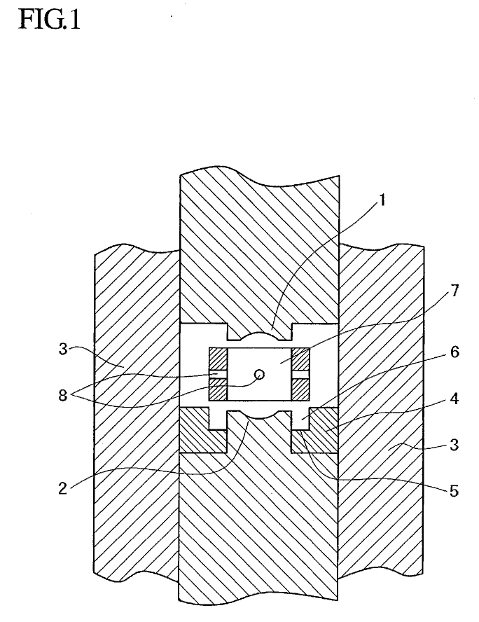

Embodiment 1 of this invention is explained below in reference to FIGS. 1 through 4.

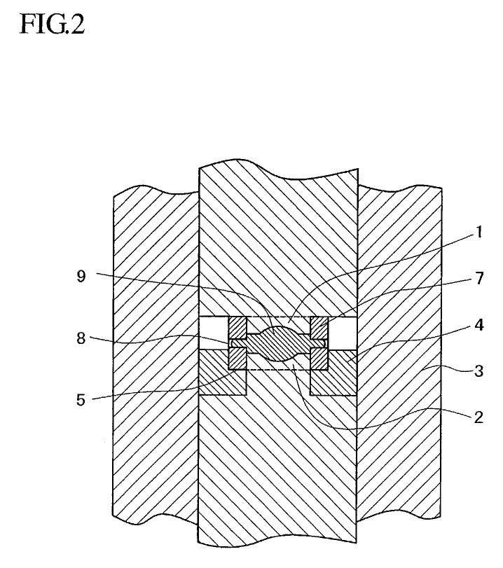

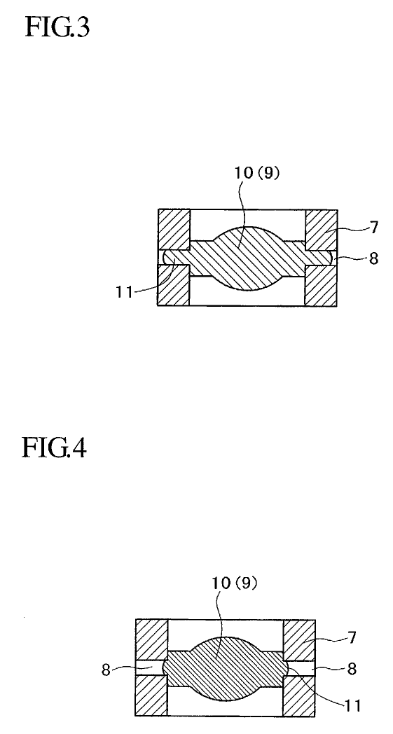

FIG. 1 is a sectional view for explanatorily illustrating the components of the device used for producing the molded glass lens of this invention. FIG. 2 is a sectional view showing a lens that is being molded. FIGS. 3 and 4 are sectional views respectively showing the molded glass lens of this invention.

In these drawings, symbols 1 and 2 denote respectively an upper mold member and a lower mold member of a mold and symbol 3 denotes a cylindrical mold holder for holding the lateral faces of the upper mold member 1 and the lower mold member 2. Symbol 4 denotes a spacer installed for the lower mold member 2. The spacer 4 forms a cutout portion 5 on the side of the lower mold member 2, to form a fitting groove 6 around the lower mold member 2. Symbol 7 denotes a lens holding cylinder to be fitted around the upper mold member 1 and the tip of the lower mold member 2, and the lens holding cylinder 7 fits in the fitting groove 6, for being supported. The lens holding cylinder 7 has through holes 8 formed in it. For Embodiment, four such through holes 8 can be formed at 90 degree intervals along the circumference of the lens holding cylinder 7, or the number of the through holes can be decided as required.

In the above constitution, as shown in FIG. 2, the space formed by the upper mold member 1, the lower mold member 2 and the lens holding cylinder 7 is used as a hot working space, and a lens base material 9 is placed in the space. The lens base material 9 is heated and molded by hot working to produce a predetermined molded glass lens 10.

Since the hot working is performed in the space formed by the upper mold member 1, the lower mold member 2 and the lens holding cylinder 7, the glass lens 10 is fixed integrally with the lens holding cylinder 7, as soon as it is molded. Since the lens holding cylinder 7 is fitted in the fitting groove 6 of the spacer 4 and held in predetermined positional relation with the lower mold member 2, the molded glass lens 10 can be precisely fixed in a predetermined position of the lens holding cylinder 7.

In this case, the excessive portion 11 of the lens base material 9 flows into the through holes 8, for being absorbed, and does not adversely affect the molding of the lens portion. Since the means for absorbing the excessive portion 11 of the lens base material is the through holes 8 formed in the lens holding cylinder 7 as described above, the lens can be worked easily and highly precisely, and since the diameter of the through holes 8 can be decided to adequately set the flow resistance of the excessive lens base material 9, a highly precise glass lens can be molded. Meanwhile, FIG. 3 shows a case where the excessive portion 11 of the lens base material 9 is large, and FIG. 4 shows a case where the excessive portion 11 of the lens base material 9 is small.

Particular dimensions in the above-mentioned Embodiment are, for instance, as follows:

[Lens Holding Cylinder 7]

Outer diameter . . . 3 mm, inner diameter . . . 2 mm, height . . . 1.6 mm, diameter of through holes . . . 0.6 mm

[Molded Glass Lens 10]

Thickness at the central portion . . . 1.2 mm

[Lens Base Material 9 (Sphere)]

Diameter . . . 1.8 mm, volume . . . 3.05 mm³

In the above constitution, the total volume of the through holes 8 is 0.56 mm³, and since the volume that can be used for keeping the excessive lens base material remaining in the through holes without leaking beyond the circumference is about 80%, the effective volume is 0.45 mm³.

This corresponds to 15% of the volume of the lens base material 9.

So, it can be seen that the four through holes 8 formed in the lens holding cylinder 7 can absorb 15% volume fluctuation (5% diameter fluctuation) of the lens base material 9. If the hole diameter of the through holes 8 is too large, the pressure acting on the molded face during molding declines. So, the diameter cannot be made too large. A diameter of 1 mm or less is desirable, though depending on the molding temperature and the radius of curvature of the molded face.

### Embodiment 2

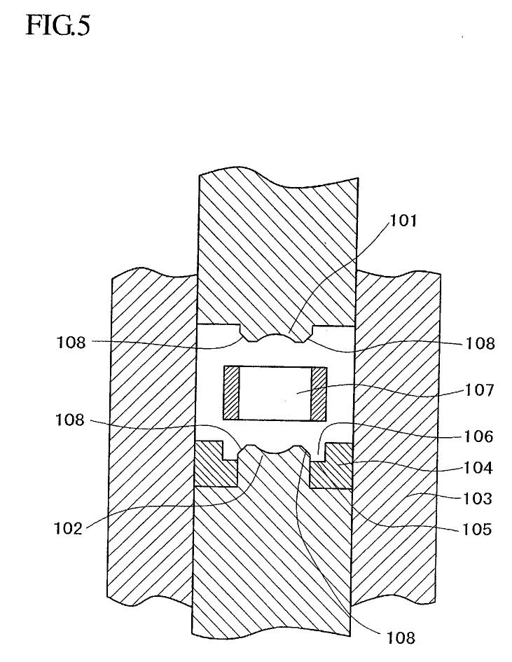

Embodiment 2 of this invention is explained below in reference to FIGS. 5 through 8.

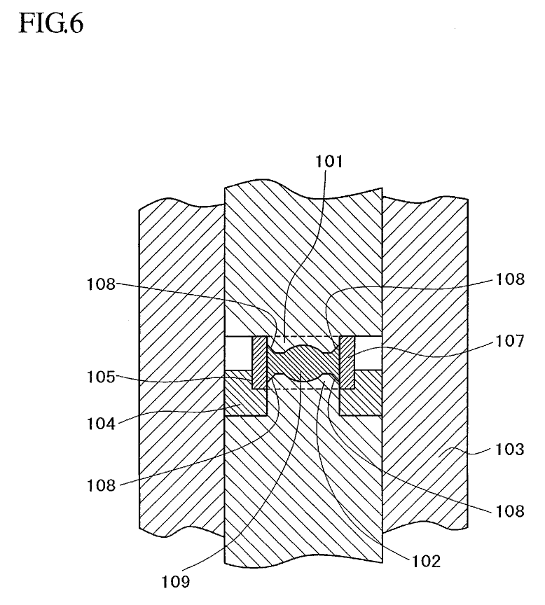

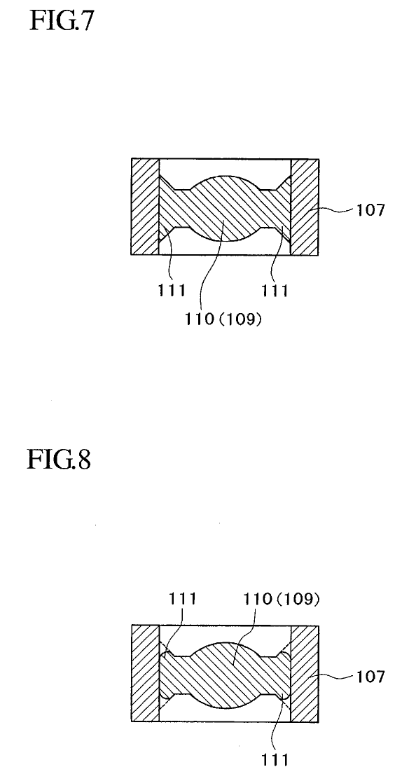

FIG. 5 is a sectional view for explanatorily expressing the components of the device for producing the molded glass lens of this invention. FIG. 6 is a sectional view showing a lens that is being molded. Furthermore, FIGS. 7 and 8 are sectional views respectively showing the molded glass lens of this invention.

In these drawings, symbols 101 and 102 denote respectively an upper molded member and a lower molded member of a mold and symbol 103 denotes a cylindrical mold holder for holding the lateral faces of the upper mold member 101 and the lower mold member 102. Symbol 104 denotes a spacer installed for the lower mold member 102. The spacer 104 forms a cutout portion 105 on the side of the lower mold member 102, to form a fitting groove 106 around the lower mold member 102. Symbol 107 denotes a lens holding cylinder to be fitted around the upper mold member 101 and the tip of the lower mold member 102, and the lens holding cylinder 107 fits in the fitting groove 106, for being supported. Furthermore, at least one of the upper mold member 101 and the lower mold member 102, both the upper mold member 101 and the lower mold member 102 in this Embodiment have chamfered portions 108 at the circumferential edges, to be kept in contact with the inner circumferential face of the lens holding cylinder 107 during molding.

In the above constitution, as shown in FIG. 6, the space formed by the upper mold member 101, the lower mold member 102 and the lens holding cylinder 107 is used as a hot working space, and a lens base material 109 is placed in it and heated and molded by hot working to produce a predetermined molded glass lens 110.

As described for Embodiment 1, the hot working is performed in the space formed by the upper mold member 101, the lower mold member 102 and the lens holding cylinder 107. So, the glass lens 110 is fixed integrally with the lens holding cylinder 107 as soon as it is molded. Since the lens holding cylinder 107 is fitted in the fitting groove 106 of the spacer 104, and supported in predetermined positional relation with the lower mold member 102, the molded glass lens 110 can be precisely fixed at a predetermined position of the lens holding cylinder 107.

In this case, the excessive portion 111 of the lens base material 109 can flow into the spaces corresponding to the chamfered portions 108 formed at the circumferential edges of the upper mold member 101 and the lower mold member 102, to be kept in contact with the inner circumferential face of the lens holding cylinder 107 during molding. So, the excessive portion 111 swells in contact with the inner circumferential face of the lens holding cylinder 107, for being absorbed. Meanwhile, FIG. 7 shows a case where the excessive portion 111 of the lens base material 109 is large, and FIG. 8 shows a case where the excessive portion 111 of the lens base material 109 is small.

Particular dimensions in the above-mentioned Embodiment are, for instance, as follows:

[Chamfered Portions 108]

Chamfered dimension . . . 0.2 mm

volume of chamfered portion (one side) . . . 0.12 mm³

[Molded Glass Lens 110]

Thickness of the central portion . . . 1.2 mm

[Lens Base Material 109 (Sphere)]

Diameter . . . 1.8 mm, volume . . . 3.05 mm³

In the above constitution, if the effective volume of the chamfered portions 108 corresponds to 80% of the chambered portions of both sides, it is 0.19 mm3, and it can be seen that 6% volume fluctuation (2% diameter fluctuation) of the lens base material 109 can be absorbed.

### INDUSTRIAL APPLICABILITY

This invention is as described above. So, even in the case where the produced molded glass lens with a lens holding cylinder integrated is small, the level required in the volume control of the lens base material can be lowered. In addition, this invention has the following advantages and is industrially highly applicable.

1. The structure of the molding device can be simplified.

2. Like an ordinary lens, the lens can be precisely supported at its outer diameter portion in an optical apparatus.

3. The molded lens is not limited in size.

4. The lens can be produced at low cost.

What is claimed is:

1. A molded glass lens with a lens holding cylinder integrated, comprising the lens holding cylinder having an adequate number of through holes formed in it and forming a hot working space together with a mold during molding and a glass lens proper molded in the lens holding cylinder, wherein the excessive portion of the base material of the lens has flowed into said through holes.

2. A device for producing a molded glass lens comprising: a lens holding cylinder integrated, by hot-working the base material of the lens using a mold, wherein the lens holding cylinder comprises an upper mold member and a lower mold member during molding, to constitute the space formed by the upper mold member, the lower mold member and the lens holding cylinder as a hot working space, and that an adequate number of through holes are formed in the lens holding cylinder.

3. A molded glass lens with a lens holding cylinder integrated, comprising the lens holding cylinder forming a hot working space together with a mold during molding and a glass lens proper molded in the lens holding cylinder, wherein the excessive portion of the base material of the lens is swollen in contact with the inner circumferential face of said lens holding cylinder.

4. A device for producing a molded glass lens comprising a lens holding cylinder integrated, by hot-working the base material of the lens using a mold, characterized in that the lens holding cylinder is arranged around an upper mold member and a lower mold member during molding, to constitute the space formed by the upper mold member, the lower mold member and the lens holding cylinder as a hot working space, and that a chamfered portion is formed at the circumferential edge of at least either the upper mold member or the lower mold member, to be kept in contact with the inner circumferential face of the lens holding cylinder during molding.
